(19) United States
(12) Patent Application Publication
(10) Pub. No.: US 2023/0385540 A1
(43) Pub. Date: Nov. 30, 2023

(54) INFORMATION PROCESSING METHOD, INFORMATION PROCESSING APPARATUS, AND STORAGE MEDIUM

(71) Applicant: CANON KABUSHIKI KAISHA, Tokyo (JP)

(72) Inventor: YUUKI WAKABAYASHI, Kanagawa (JP)

(21) Appl. No.: 18/315,243

(22) Filed: May 10, 2023

(30) Foreign Application Priority Data
May 25, 2022 (JP) 2022-084980

(51) Int. Cl. G06F 40/186; G06F 40/106; G06F 16/33

(52) U.S. Cl. CPC G06F 40/186; G06F 40/106; G06F 16/3334

(57) ABSTRACT

Print image data for variable data printing is generated by using a database in which text objects associated with fields included in the database can be viewed on the database. First, a database is obtained. Next, out of one or more text objects included in edition data indicating a layout, a text object of the text objects including a character-string data piece corresponding to an attribute character-string data piece indicating each of one or more attributes included in the database is identified. Then, layout data is generated by replacing the character-string data piece included in the identified text object with a data piece in a record included in the database, the data piece in the record corresponding to the attribute associated with the identified text object.

### BACKGROUND

### Field

The present disclosure relates to a technique for generating print data for variable data printing.

### Description of the Related Art

A technique is known for generating print data to lay out characters, character strings, or the like (hereinafter simply referred to as “character strings”) desired by the user for printing, by using a template of a layout prepared in advance and inserting data of the corresponding character strings into the template. For example, in the field of printing post cards such as new year's cards, there is application software that provides a function of performing printing by loading a database of an address book or the like and inserting data of character strings included in the loaded database into the address field, the name field, and the like on the address side of post cards. This function is called a variable information printing function or also called a variable data printing function. Japanese Patent Laid-Open No. 2003-337810 discloses a technique to perform printing by arranging visible character strings, as attribute names, in the input fields such as the address field and the name field on the address side of a post card and inserting data of the corresponding character string into the input field having the attribute name corresponding to an attribute name included in the database.

Also, in the field of creating posters, an application software for laying out character strings to generate print data is known (hereinafter referred to as “poster creation application”). Some poster creation applications provide a so-called variable data printing function of inserting data in records included in a database into a template of a layout (hereinafter simply referred to as “template”) prepared in advance to perform printing. In a case where data in records included in a database is inserted into a template prepared in advance to perform printing, the user, for example, first selects a text object in the template on a layout editing screen. Next, the user selects, out of a plurality of attributes (hereinafter referred to as “fields”) included in the loaded database, a field corresponding to the data in the records that the user wants to insert into the selected text object. In this way, the data in the records, corresponding to the selected field, included in database is inserted at the position corresponding to the selected text object.

In the case of generating print data by inserting data in records included in a database into a template prepared in advance, it is sometimes difficult to determine which text object in the template a field included in the database is associated with.

### SUMMARY

An information processing method according to the present disclosure is an information processing method including: obtaining a database; identifying, out of one or more text objects included in edition data indicating a layout, a text object of the text objects including a character-string data piece corresponding to an attribute character-string data piece indicating each of one or more attributes included in the database; and generating layout data by replacing the character-string data piece included in the text object identified in the identifying with a data piece in a record included in the database, the data piece in the record corresponding to the attribute associated with the text object.

Further features of the present disclosure will become apparent from the following description of exemplary embodiments with reference to the attached drawings.

### BRIEF DESCRIPTION OF THE DRAWINGS

FIG. 1 is a block diagram illustrating an example of functional constituents of an information processing apparatus;

FIG. 2 is a block diagram illustrating an example of the hardware configuration of the information processing apparatus;

FIG. 3 illustrates an example of a GUI generated by the information processing apparatus;

FIG. 4 is a table for explaining an example of a database;

FIG. 5A is a diagram for explaining an example of template data obtained by a template obtaining unit, and FIGS. 5B, 5C, and 5D are diagrams for explaining examples of layout data generated by a generation unit;

FIG. 6 is a flowchart illustrating an example of a process flow of the information processing apparatus;

FIG. 7 is a block diagram illustrating an example of functional constituents of an information processing apparatus;

FIG. 8 is a flowchart illustrating an example of a process flow of the information processing apparatus;

FIG. 9 is a block diagram illustrating an example of functional constituents of an information processing apparatus;

FIG. 10 is a flowchart illustrating an example of a process flow of the information processing apparatus;

FIG. 11 is a block diagram illustrating an example of functional constituents of an information processing apparatus; and

FIG. 12 is a flowchart illustrating an example of a process flow of the information processing apparatus.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### Embodiment 1

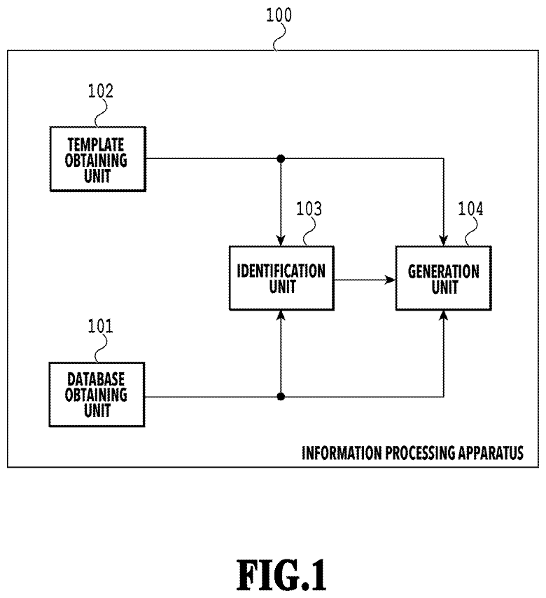

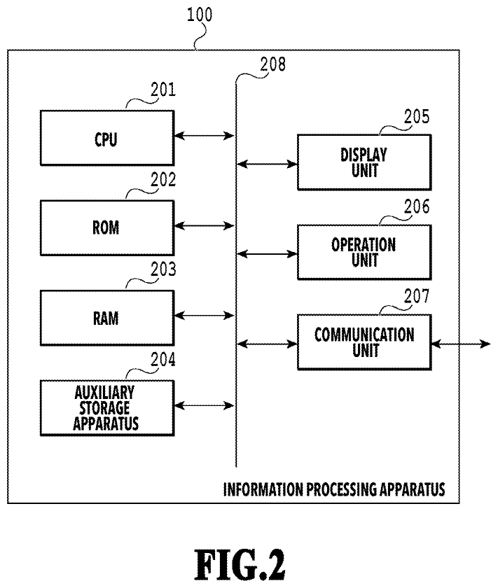

An information processing apparatus 100 according to Embodiment 1 will be described with reference to FIGS. 1 to 6. First, the configuration of the information processing apparatus 100 according to Embodiment 1 will be described with reference to FIGS. 1 and 2. FIG. 1 is a block diagram illustrating an example of functional constituents of the information processing apparatus 100 according to Embodiment 1. The information processing apparatus 100 includes a database obtaining unit 101, a template obtaining unit 102, an identification unit 103, a generation unit 104, and an output control unit 105. Processes of these units included as functional constituents in the information processing apparatus 100 will be described later.

### <Hardware Configuration of Information Processing Apparatus>

The hardware configuration of the information processing apparatus 100 will be described. The processes of the units illustrated in FIG. 1 as an example, included in the information processing apparatus 100 are implemented by hardware such as an application specific integrated circuit (ASIC) included in the information processing apparatus 100. These processes may be implemented by hardware such as a field programmable gate array (FPGA). Alternatively, these processes may be implemented by software with a processor such as a central processing unit (CPU) or a graphic processing unit (GPU) and memory such as random access memory (RAM). In this case, for example, the information processing apparatus 100 is composed of a personal computer (hereinafter referred to as “PC”). Note that the PC is a mere example, and any unit can be used which is capable of displaying and editing text and implementing the processes of the functional constituents included in the information processing apparatus 100 by using software. Specifically, for example, the information processing apparatus 100 may be composed of a mobile terminal, a laptop PC, a tablet terminal, a personal digital assistant (PDA), or the like.

FIG. 2 is a block diagram illustrating an example of the hardware configuration of the information processing apparatus 100 according to Embodiment 1 for a case where the units included as functional constituents in the information processing apparatus 100 illustrated in FIG. 1 as an example are operated by software. The information processing apparatus 100 is composed of a computer, and the computer includes a CPU 201, ROM 202, RAM 203, an auxiliary storage apparatus 204, a display unit 205, an operation unit 206, a communication unit 207, and a bus 208 as illustrated in FIG. 2 as an example.

The CPU 201 uses programs or data stored in the ROM 202 or the RAM 203 to control the computer, so that the computer functions as the units included as functional constituents in the information processing apparatus 100 illustrated in FIG. 1. Note that the information processing apparatus 100 may include one or more pieces of dedicated hardware separately from the CPU 201, and at least part of the processes performed by the CPU 201 may be executed by the dedicated hardware. Examples of the dedicated hardware include an ASIC, an FPGA, and a digital signal processor (DSP). The ROM 202 stores programs and the like that require no modification. The RAM 203 temporarily stores programs or data supplied from the ROM 202, the auxiliary storage apparatus 204, or the like and also temporarily stores data or the like supplied from the outside via the communication unit 207. The auxiliary storage apparatus 204, which is composed of, for example, a hard disk drive or the like, stores programs or image data, or various kinds of data such as audio data.

The display unit 205 is composed of, for example, a liquid crystal display, an LED, or the like and displays graphical user interfaces (GUIs) and the like for the user to operate or browse on the information processing apparatus 100. The operation unit 206 includes, for example, a keyboard, a mouse, a joy stick, or a touch panel, and, in response to the user's operations, inputs various instructions to the CPU 201. The CPU 201 operates as a display control unit that controls the display unit 205 and an operation control unit that controls the operation unit 206.

The communication unit 207 is used for communication with an apparatus outside the information processing apparatus 100. For example, in a case where the information processing apparatus 100 is connected to an external apparatus with wiring, a communication cable is connected to the communication unit 207. In a case where the information processing apparatus 100 has a function of wireless communication with an external apparatus, the communication unit 207 includes an antenna. The bus 208 connects the units included as hardware constituents in the information processing apparatus 100 to one another and is used for information communication. Although Embodiment 1 is described on the assumption that the display unit 205 and the operation unit 206 are included in the information processing apparatus 100, at least one of the display unit 205 and the operation unit 206 may be a separate apparatus outside the information processing apparatus 100.

### <Processes of Units Included as Functional Constituents in Information Processing Apparatus>

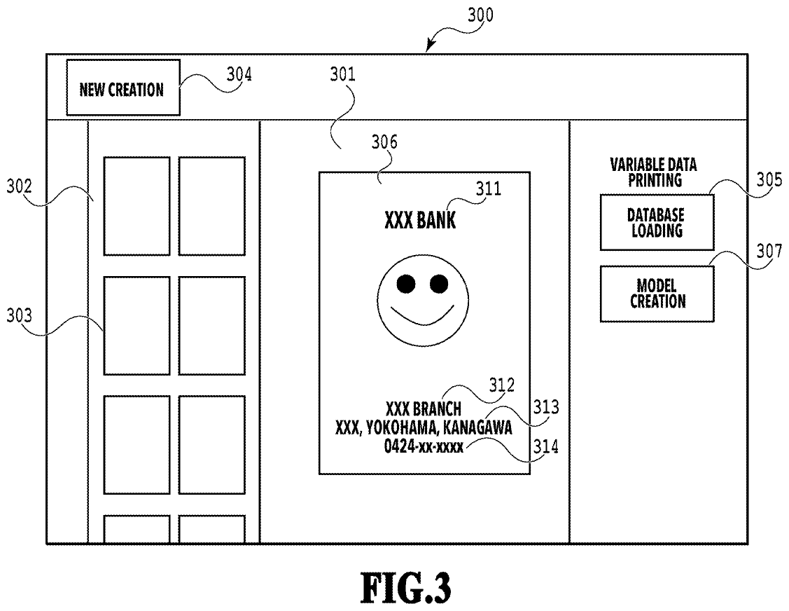

Processes of the units included as functional constituents in the information processing apparatus 100 will be described. The output control unit 105 generates GUIs for the user to operate or browse on the information processing apparatus 100. In addition, the output control unit 105 outputs signals of generated GUIs to the display unit 205 and displays the GUIs on the display unit 205. A GUI that the information processing apparatus 100 generates will be described with reference to FIG. 3. FIG. 3 illustrates an example of a GUI that is generated by the information processing apparatus 100 according to Embodiment 1 and displayed on the display unit 205. Specifically, FIG. 3 illustrates an example of an editing screen 300 as an example of a GUI for the user to create or edit (hereinafter, these operations are collectively referred to as “editing”) data for a layout (hereinafter also referred to as “layout data”) of a poster or the like.

The editing screen 300 includes, as an example, a preview area 301, a template selection area 302, a new creation button 304, a database loading button 305, and a model creation button 307. The preview area 301 shows a preview image 306 of layout data being edited, and the user uses the preview area 301 to check or change the layout being edited or after edition. The template selection area 302 shows thumbnail images 303 associated with data for templates of a plurality of layouts having different designs or layouts (hereinafter, a template of a layout will be simply referred to as “template”, and data for a template will be referred to as “template data”).

The template obtaining unit 102 obtains template data. Specifically, for example, the template obtaining unit 102 obtains template data by loading template data prestored in the auxiliary storage apparatus 204 or the like. For example, the template obtaining unit 102 obtains template data associated with a thumbnail image 303 selected by the user's operation. The template data obtained by the template obtaining unit 102 is used as edition data.

The output control unit 105 uses the template data obtained by the template obtaining unit 102 to generate a preview image 306 and displays the preview image 306 in the preview area 301. How to edit layout data is not limited to the way of editing by using template data selected by selection of a thumbnail image 303. For example, when the user presses the new creation button 304, the user can edit layout data from a state of an initial layout such as blank paper or the like.

The following description is an example based on the assumption that the template data obtained by the template obtaining unit 102 corresponds to the preview image 306 illustrated in FIG. 3 as an example. In addition, the following description is also based on the assumption that the template data includes a plurality of text objects 311 to 314 as illustrated in the preview image 306 in FIG. 3 as an example. Specifically, the description is based on the assumption that the text object 311 includes data of a character string “xxx bank” and that the text object 312 includes data of a character string “xxx branch”. In addition, the description is also based on the assumption that the text object 313 includes data of a character string “xxx Yokohama, Kanagawa” and that the text object 314 includes data of a character string “0424-xx-xxxx”.

The database obtaining unit 101 obtains data for a database (hereinafter simply referred to as “database”). Specifically, for example, the database obtaining unit 101 obtains a database by loading a database prestored in the auxiliary storage apparatus 204 or the like. For example, when the database loading button 305 is pressed by the user's operation, the output control unit 105 generates a GUI for selecting a file including a database to be loaded (hereinafter referred to as “selection GUI”). The output control unit 105 outputs the generated selection GUI (not illustrated in FIG. 3) to the display unit 205 and displays the generated selection GUI on the display unit 205. The user operates the selection GUI displayed on the display unit 205 to select a desired file. The database obtaining unit 101 obtains a database by loading the file selected by the user's operation from the auxiliary storage apparatus 204. The method of obtaining a database is not limited to the one described above and may be any method that enables uniquely selecting a file including a database. For example, the user may drag & drop an icon of a file including a database onto the editing screen 300 to specify the database to be obtained by the database obtaining unit 101. Note that the model creation button 307 will be described later in Embodiment 3.

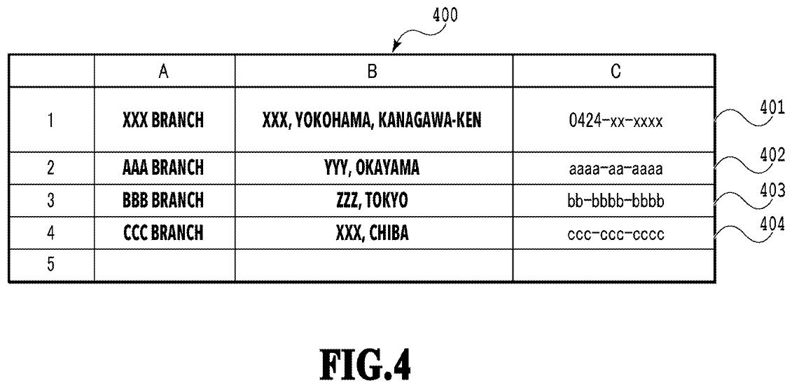

A database obtained by the database obtaining unit 101 will be described with reference to FIG. 4. FIG. 4 is a table for explaining an example of a database 400 according to Embodiment 1. The first row 401 of the database 400 includes data of character strings indicating attributes of each record data in the database such that each column includes an attribute. The character string in each column in the first row 401 is identical with the character string in at least one of the text objects 311 to 314 included in the template data. Each column in the second and subsequent rows 402 to 404 includes record data corresponding to the attribute indicated in the first row 401. The character strings included in each column in the second and subsequent rows 402 to 404 are character strings for replacing the character string of each text object included in the template data.

Specifically, as described above, the selected template data includes, as text objects, data of character strings: “xxx bank”, “xxx branch”, “xxx, Yokohama, Kanagawa”, and “0424-xx-xxxx”. The A column in the first row 401 of the database 400 contains “xxx branch” which corresponds to the character string included in the text object 312, “xxx branch”. Similarly, the B column in the first row 401 of the database 400 contains “xxx, Yokohama, Kanagawa” which corresponds to the character string included in the text object 313, “xxx, Yokohama, Kanagawa”. Similarly, the C column in the first row 401 of the database 400 contains “0424-xx-xxxx” which corresponds to the character string included in the text object 314, “0424-xx-xxxx”. The character strings contained in the columns in the first row and, in other words, the character strings indicating attributes, are referred to as “field names” in the following description.

The A column in the second row 402 of the database 400 contains a character string “aaa branch” for replacing “xxx branch” in the text object 312 included in the template data. Similarly, the B column in the second row 402 contains a character string “yyy, Okayama” for replacing “xxx, Yokohama, Kanagawa” included in the text object 313. The C column in the second row 402 contains a character string “aaaa-aa-aaaa” for replacing “0424-xx-xxxx” included in the text object 314. The character strings in each column in the third row 403 and the fourth row 404 of the database 400 are similar to the one in each column in the second row 402, and thus, description thereof is omitted.

The identification unit 103 identifies, for each field name included in the database, a text object including the character string corresponding to each field name out of one or more text objects included in the edition data. Here, the edition data is, for example, template data obtained by the template obtaining unit 102. Specifically, the identification unit 103 identifies, for the character string contained in each column in the first row 401 of the database 400, a text object including the character string corresponding to the field name out of the text objects 311 to 314. Here, the text object including the character string corresponding to the field name is a text object including the character string identical with the field name. Thus, the identification unit 103 determines that the text object including the character string contained in the A column in the first row 401 of the database 400 is the text object 312. Similarly, the identification unit 103 determines that the text object including the character string contained in the B column in the first row 401 of the database 400 is the text object 313. Similarly, the identification unit 103 determines that the text object including the character string contained in the C column in the first row 401 is the text object 314.

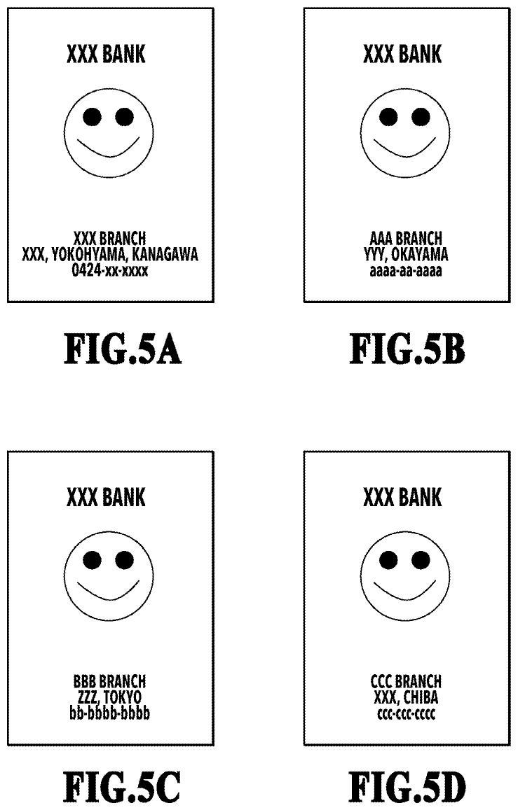

The generation unit 104 generates layout data by replacing character strings of text objects included in edition data such as template data with record data. Specifically, the generation unit 104 replaces the character string of the text object determined by the identification unit 103 with the record data in a column of the first row 401 in the database 400, the column including the character string identical with the determined character string. Layout data generated by the generation unit 104 will be described with reference to FIGS. 5A to 5D. FIG. 5A illustrates an example of template data obtained by the template obtaining unit 102 according to Embodiment 1. FIGS. 5B to 5D illustrate examples of layout data generated by the generation unit 104 according to Embodiment 1.

For example, first, the generation unit 104 replaces the data of the character string included in the text object 312 with the data of the character string contained in the A column in the second row 402 of the database 400. Similarly, the generation unit 104 replaces the data of the character string included in the text object 313 with the data of the character string contained in the B column in the second row 402 of the database 400. The generation unit 104 also replaces the data of the character string included in the text object 314 with the data of the character string contained in the C column in the second row 402 of the database 400. In this way, the generation unit 104 generates the layout data illustrated in FIG. 5B as an example.

Next, the generation unit 104 replaces the data of the character string included in the text object 312 with the data of the character string contained in the A column in the third row 403 of the database 400. Similarly, the generation unit 104 replaces the data of the character strings included in the text object 313 and the text object 314 with the data of the character strings contained in the B column and the C column in the third row 403 of the database 400. In this way, the generation unit 104 generates the layout data illustrated in FIG. 5C as an example.

Further, the generation unit 104 replaces the data of the character string included in the text object 312 with the data of the character string contained in the A column in the fourth row 404 of the database 400. Similarly, the generation unit 104 replaces the data of the character strings included in the text object 313 and the text object 314 with the data of the character strings contained in the B column and the C column in the fourth row 404 of the database 400. In this way, the generation unit 104 generates the layout data illustrated in FIG. 5D as an example. In this way, the generation unit 104 sequentially generates the layout data corresponding to all of the records included in the database.

The layout data generated by the generation unit 104 is, for example, outputted to the auxiliary storage apparatus 204 and stored in the auxiliary storage apparatus 204. Note that the output destination of the generated layout data is not limited to the auxiliary storage apparatus 204. For example, the generated layout data may be outputted to an image forming apparatus such as a printer and may be printed (recorded) on printing media. Note that in a case where the generated layout data is printed on printing media with an image forming apparatus, the generated layout data may be outputted to a printer driver or the like, and the printer driver may execute printing of the layout data. Alternatively, for example, the generated layout data may be outputted to a world wide web (WWW) server and used for posting on a Web page. In addition, for example, the generated layout data may be outputted to social media (social networking services) and used for posting on the social media.

### <Operation of Information Processing Apparatus>

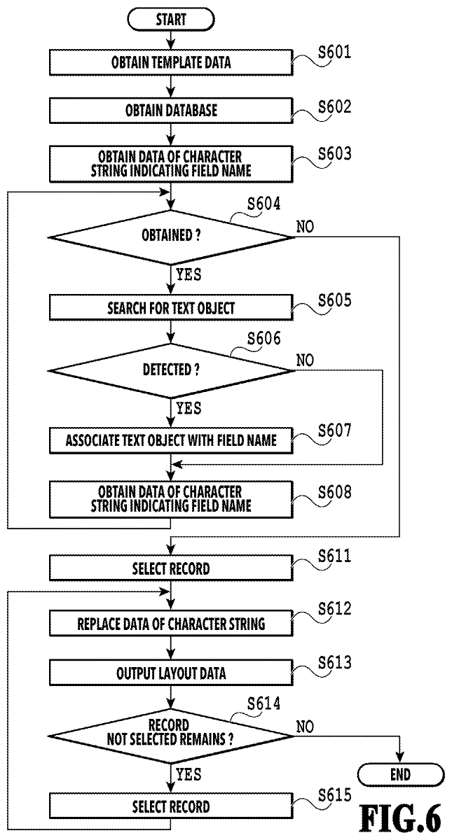

The operation of the information processing apparatus 100 will be described with reference to FIG. 6. FIG. 6 is a flowchart illustrating an example of a process flow of the information processing apparatus 100 according to Embodiment 1. Note that in the description of FIG. 6, the symbol “S” denotes “step”. Here, it is assumed that while the flowchart illustrated in FIG. 6 is being executed, the output control unit 105 generates appropriate GUIs as necessary and displays the generated GUIs on the display unit 205. First, at S601, the template obtaining unit 102 obtains template data specified by the user's operation. Next, at S602, the database obtaining unit 101 obtains the database 400 specified by the user's operation.

Next, the identification unit 103 performs the processes from S603 to S608. In these processes, the identification unit 103 identifies, for each field name included in the database 400, a text object including the character string corresponding to each field name out of the text objects included in the template data. Specifically, first, at S603, the identification unit 103 selects a column out of the columns in the first row 401 of the database 400 and tries to obtain the data of the character string included in the selected column, in other words, a field name. Specifically, for example, the identification unit 103 tries to obtain the data of the character string contained in the first column, in other words, the A column in FIG. 4, in the first row 401 of the database 400. Next, at S604, the identification unit 103 determines whether the data of the character string contained in the column selected out of the columns in the first row 401 of the database 400 was obtained. If it is determined at S604 that the data of the character string was obtained, the identification unit 103, at S605, searches the template data obtained at S601 for a text object including the data of the character string that completely matches the data of the character string obtained at S603. After S605, the identification unit 103, at S606, determines whether a text object including the data of the character string making a complete match was detected at S605.

If it is determined at S606 that the text object including the data of the character string making a complete match was detected, the identification unit 103, at S607, performs the following process. At S607, the identification unit 103 determines that the text object detected at S605 corresponds to the field name included in the selected column in the first row 401 of the database 400 and associates the detected text object with the field name. In this process, for example, the identification unit 103 stores information on this association relationship in the RAM 203 or the like. After S607, or in the case where it is determined at S606 that a text object including the data of the character string making a complete match was not detected, the identification unit 103, at S608, performs the following process. At S608, the identification unit 103 selects a column that has not been selected yet (for example, the B column) out of the columns in the first row 401 of the database 400 and tries to obtain data of the character string contained in the selected column, in other words, a field name. After S608, the identification unit 103 returns to the process at S604 and executes the processes from S604 to S608 repeatedly until it is determined at S604 that data of a character string could not be obtained.

If it is determined at S604 that data of a character string could not be obtained, the generation unit 104 performs the processes from S611 to S615 and generates layout data corresponding to each record of the database 400. Specifically, first, the generation unit 104, at S611, selects a record out of the records in the second and subsequent rows of the database 400. Specifically, for example, the generation unit 104 selects the record in the second row 402 of the database 400. Next, at S612, the generation unit 104 replaces, with the data of the character string included in each column of the selected record, the data of the character string in the text object associated with the corresponding field name out of the text objects included in the template data. In this way, the layout data corresponding to the record selected at S611 is generated. Next, at S613, the generation unit 104 outputs the layout data generated at S612.

Next, at S614, the generation unit 104 determines whether a record not selected yet remains in the database 400. If it is determined at S614 that a record not selected yet remains, the generation unit 104, at S615, selects a record not selected yet (for example, the record in the third row 403). After S615, the generation unit 104 returns to S612 and executes the processes from S612 to S615 repeatedly until it is determined at S614 that a record not selected yet does not remain. If it is determined at S614 that a record not selected yet does not remain, the information processing apparatus 100 ends the processes in the flowchart illustrated in FIG. 6.

With the information processing apparatus 100 configured as described above, it is possible to generate print data (layout data) for variable data printing by using a database in which field names associated with text objects can be recognized on the database.

Note that the present embodiment described, as an example, a configuration using the database 400 in which each column has a name such as A for the first column and B for the second column, as illustrated in FIG. 4; however, the configuration of the database is not limited to the one described above. The database may have any configuration in which field names and records can be distinguished, for example, a text file in a comma-separated values (CSV) format. In addition, the present embodiment uses a database in which the first row has field names and the second and subsequent rows have record data; however, the configuration of the database is not limited to the one described above. The database may have any configuration in which field names and record data can be distinguished such as one in which, for example, the rows and the columns are switched such that the first column has field names and that the second and subsequent columns have record data.

The present embodiment described a configuration in which when searching the template data for a text object including the data of the character string that completely matches the data of the character string obtained at S603, only one fit text object is detected. For example, in this search operation, in the case where a plurality of fit text objects are detected, a text object first detected may be determined to be the one corresponding to the field name included in the column selected out of the columns in the first row 401 of the database 400. Note that the above method of determining the correspondence relationship between the text object and the field name in this case is a mere example, and the identification method may be any method that can uniquely determine the correspondence relationship between the text object and the field name. For example, the identification method may be one in which the user selects a desired text object out of a plurality of text objects detected in the search operation. In this case, the output control unit 105 generates a GUI that enables the user to select a desired text object out of a plurality of detected text objects and displays the generated GUI on the display unit 205.

The present embodiment illustrates an example that uses, as edition data, template data having text objects arranged in advance and in which the character string data in the text objects included in the template data is replaced with the record data included in the database. However, the present embodiment is not limited to such configurations. For example, instead of template data, edition data may be data that the user creates by arranging text objects on blank sheet data. In this case, the character string data in the text objects included in the edition data created by the user is replaced with data of the records included in a database. In other words, the information processing apparatus 100 according to the present embodiment can widely support edition data including text objects such as template data and data created by users.

### Modification Example 1 of Embodiment 1

The information processing apparatus 100 according to Embodiment 1 is one that replaces the data of the character string of text objects with the data of the character string included each column of records. However, there are cases where the length of a character string of record data in the replacement source is longer than the length of the character string of the text object in the replacement destination. In such a case, if the replacement is performed as it is, there is a possibility that the layout can collapse such that a character string after replacement extends over a print document or overlaps another object.

For such cases, the output control unit 105 may perform output control such as displaying a GUI (for example, a warning dialog box or the like) for warning or alerting the user on the display unit 205. Note that the method of outputting the warning or the like to the user is not limited to displaying a warning dialog box or the like and may be any method recognizable by the user, for example, outputting sound such as voice sound or signal sound.

Note that comparison between the length of a character string in the record data in the replacement source and the length of the character string in a text object in the replacement destination is performed by a comparison unit not illustrated in FIG. 1. The comparison unit, for example, compares the number of characters in a character string in the record data in the replacement source with the number of characters in the character string in the text object in the replacement destination. In the case where the number of characters in the character string in the record data in the replacement source is larger than the number of characters in the character string in the text object in the replacement destination, the output control unit 105 performs output control such as warning as described above.

The method of comparing the length of a character string in the record data in the replacement source with the length of the character string in a text object in the replacement destination performed by the comparison unit is not limited to comparison of the number of characters in character strings. For example, the comparison unit may compare the widths of the character strings displayed in two images obtained by rendering edition data (for example, template data) and layout data. In any comparison method, the output control unit 105 may perform output control such as warning described above in the case where there is a possibility that the length of the character string in the record data in the replacement source can be longer than the length of the character string in the text object in the replacement destination.

With the information processing apparatus 100 configured as described above, the user can realize that there is a possibility that the layout in the layout data can collapse.

### Modification Example 2 of Embodiment 1

In the information processing apparatus 100 according to Modification Example 1 of Embodiment 1, output control such as warning is performed when the length of a character string in the record data in the replacement source is longer than the length of the character string in the text object in the replacement destination. In contrast, the information processing apparatus 100 according to Modification Example 2 of Embodiment 1, in such cases, reduces the font size of the character string in the text object after replacement in the layout data.

Specifically, the font size is reduced such that the width of the text object after replacement displayed in the image obtained by rendering layout data is within the width of the text object before replacement displayed in the image obtained by rendering edition data. For example, the font size is reduced in certain steps until the width of the displayed text object after replacement is within the width of the displayed text object before replacement. The method of reducing the font size is not limited to the one above and may be any method capable of reducing the font size such that the width of the displayed text object after replacement is within the width of the displayed text object before replacement.

With the information processing apparatus 100 configured as described above, it is possible to prevent a layout in layout data from collapsing.

### Embodiment 2

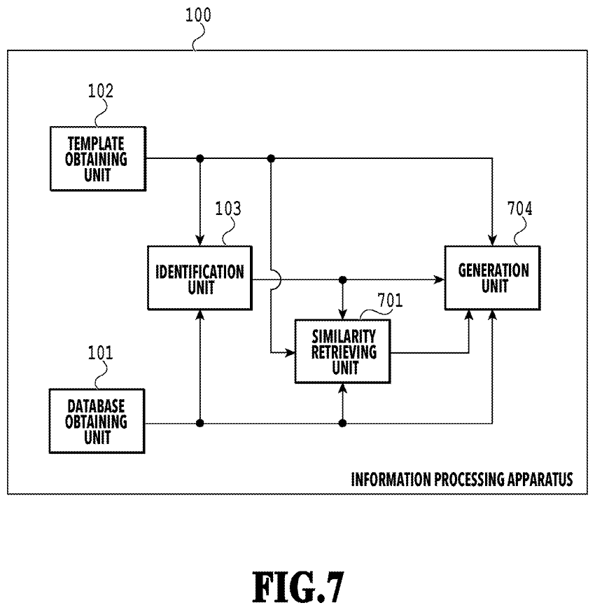

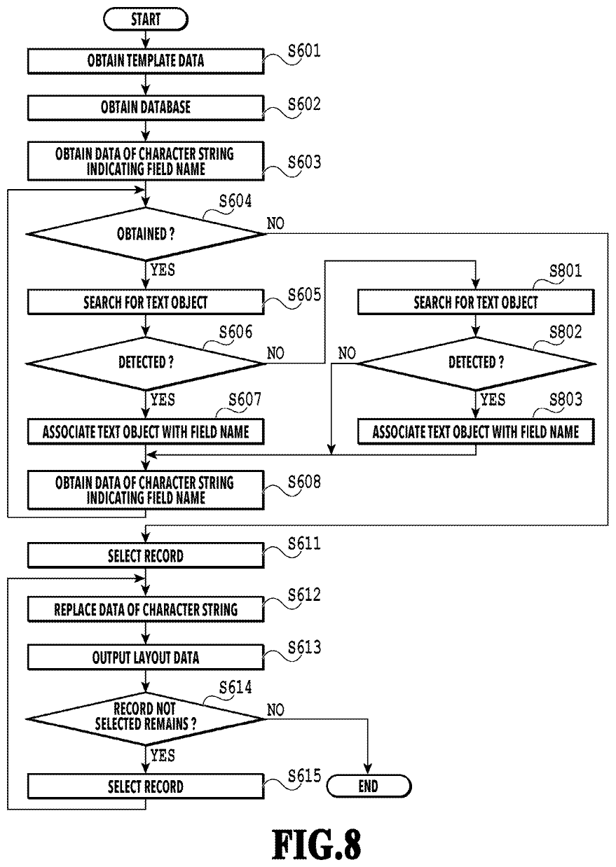

An information processing apparatus 100 according to Embodiment 2 (hereinafter also simply referred to as “information processing apparatus 100”) will be described with reference to FIGS. 7 and 8. The information processing apparatus 100 according to Embodiment 1 searches edition data and determines a text object including the character string that completely matches the field name included in the database 400. However, in a method involving searching for a character string that makes a complete match, in a case where the user makes a wrong setting by making a mistake in typing or for other reasons when the user sets field names or in other like cases, there is a possibility that a text object corresponding to a desired field name cannot be identified. In the present embodiment, a description will be given of a configuration having an improved operability for a case where the user makes a wrong setting for field names of the database 400 by making a mistake in typing or for other reasons, or in other like cases.

The configuration of the information processing apparatus 100 will be described with reference to FIG. 7. FIG. 7 is a block diagram illustrating an example of functional constituents of the information processing apparatus 100 according to Embodiment 2. The information processing apparatus 100 includes a database obtaining unit 101, a template obtaining unit 102, an identification unit 103, a generation unit 704, an output control unit 105, and a similarity retrieving unit 701. Note that in the following description, processes the same as or similar to those of the information processing apparatus 100 according to Embodiment 1 are denoted by the same symbols as in FIG. 1, and description thereof is omitted. Note that processes of the units included as functional constituents in the information processing apparatus 100 are implemented by hardware such as an ASIC or an FPGA included in the information processing apparatus 100 in a way the same as or similar to that in the information processing apparatus 100 according to Embodiment 1. These processes may be implemented by software with memory such as RAM and a processor such as a CPU.

The similarity retrieving unit 701 retrieves a text object including a character string similar to a field name included in the database 400 from edition data (for example, template data) (hereinafter, this operation is referred to as “similarity retrieval”). Specifically, for example, the similarity retrieving unit 701 performs similarity retrieval by retrieving a text object including a character string that completely matches part of the character string of a field name (hereinafter referred to as “partial character string”) from the edition data. Here, a partial character string denotes a character string from the first character to the character at a predetermined location (for example, first to fifth characters) out of a field name (hereinafter referred to as “leading character string”). The partial character string may be a character string from the character at a predetermined location (for example, the fifth character from the end) to the last character (hereinafter referred to as “trailing character string”), or the like. The partial character string may be a character string between predetermined two locations (for example, the fifth character from the front and the fifth character from the end) out of a field name (hereinafter referred to as “middle character string”).

Here, if the number of characters in the partial character string is small, the possibility of erroneous determination about similarity is high, and if the number of characters is large, the possibility of determining a similar text object to be not similar is high. Hence, an appropriate number may be set as the number of characters in the partial character string on the purpose. Note that the similarity retrieving unit 701 may perform similarity retrieval by combining at least any two retrieval operations out of retrieval operations using each of a leading character string, a trailing character string, and a plurality of middle character strings. Alternatively, the partial character string used for the similarity retrieval may be shown to the user for the user to check whether the partial character string is one desired by the user. The method of similarity retrieval is not limited to methods of retrieving a character string including the character string that completely matches a partial character string and may be any method capable of retrieving a character string similar to a certain character string.

In the case where similarity retrieval detects a plurality of text objects including a character string similar to a field name, the similarity retrieving unit 701 determines a text object including a character string similar to the field name in the following way. For example, the similarity retrieving unit 701 determines the most similar text object out of the plurality of detected text objects to be the text object similar to the field name. Note that the above determination method in this case is a mere example, and the determination method may be any method capable of uniquely determining a text object including a character string similar to a field name. For example, the method may be one in which the user selects a text object corresponding to a desired field name out of a plurality of text objects detected by similarity retrieval. In this case, the output control unit 105 generates a GUI for the user to select a desired text object out of the plurality of text objects and displays the GUI on the display unit 205.

The generation unit 104 according to Embodiment 1 is configured to replace the character string in the text object including the character string that completely matches a field name with record data in the column corresponding to the field name. In contrast, the generation unit 704, in addition to the processes of the generation unit 104 according to Embodiment 1, performs the following process in the case where the identification unit 103 cannot identify a text object including the character string that completely matches the field name. In this case, the generation unit 704 replaces the character string of the text object including a character string similar to a field name, detected by the similarity retrieving unit 701 with the record data in the column corresponding to the field name.

The operation of the information processing apparatus 100 will be described with reference to FIG. 8. FIG. 8 is a flowchart illustrating an example of the process flow of the information processing apparatus 100 according to Embodiment 2. Note that in the description of FIG. 8, the symbol “S” denotes “step”. In addition, in the following description, processes the same as or similar to those of the information processing apparatus 100 according to Embodiment 1 are denoted by the same symbols as in FIG. 6, and description thereof is omitted. Here, it is assumed that while the flowchart illustrated in FIG. 8 is being executed, the output control unit 105 generates appropriate GUIs as necessary and displays the generated GUIs on the display unit 205.

First, the information processing apparatus 100 executes the processes from S601 to S606. If it is determined at S606 that a text object including the data of the character string that makes a complete match was detected, the information processing apparatus 100 executes the processes from S607 to S608. If it is determined at S606 that a text object including the data of the character string that makes a complete match was not detected, the similarity retrieving unit 701 executes the following processes.

First, at S801, the similarity retrieving unit 701 searches the template data obtained at S601 for a text object including the data of a character string similar to the data of the character string obtained at S603. Next, at S802, the similarity retrieving unit 701 determines whether a text object including data of a similar character string was detected at S801. If it is determined at S802 that a text object including data of a similar character string was detected, the similarity retrieving unit 701, at S803, performs the following process. At S803, the similarity retrieving unit 701 determines that the text object detected at S801 corresponds to the field name included in the selected column in the first row 401 of the database 400 and associates the text object with the field name. In this process, for example, the similarity retrieving unit 701 stores information on this association relationship in the RAM 203 or the like. After S803, or in the case where it is determined at S802 that a text object including data of a similar character string was not detected, the information processing apparatus 100 executes the process at S608. After S608, the identification unit 103 returns to the process at S604 and executes the processes from S604 to S608, including the processes from S801 to S803, repeatedly until it is determined at S604 that data of a character string could not be obtained.

If it is determined at S604 that data of a character string could not be obtained, the generation unit 704 performs the processes from S611 to S615 and generates layout data corresponding to each record in the database 400. After S615, the generation unit 704 returns to S612 and executes the processes from S612 to S615 repeatedly until it is determined at S614 that a record not selected yet does not remain. If it is determined at S614 that a record not selected yet does not remain, the information processing apparatus 100 ends the processes in the flowchart illustrated in FIG. 8.

With the information processing apparatus 100 configured as described above, it is possible to prevent a layout in layout data from collapsing. In addition, with the information processing apparatus 100, even in the case where the user made a wrong setting when setting a field name, it is possible to associate the text object corresponding to the field name with this field name.

### Embodiment 3

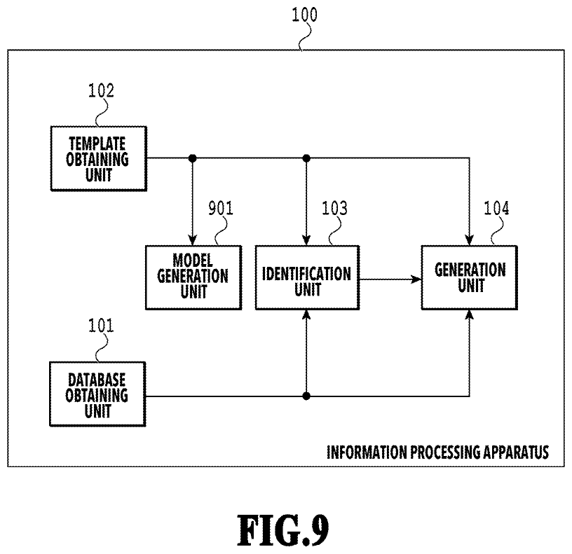

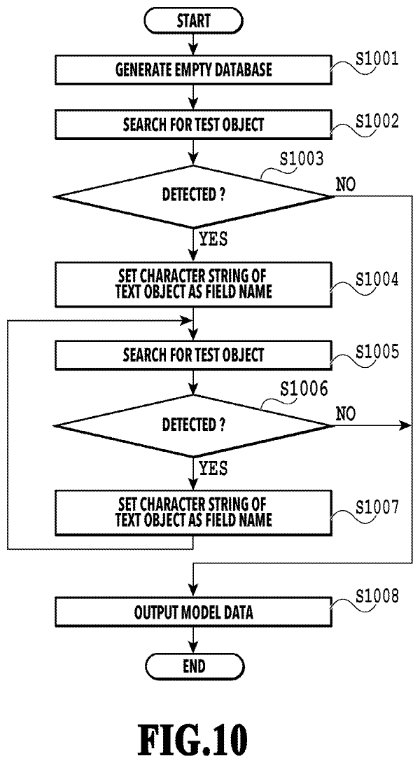

An information processing apparatus 100 according to Embodiment 3 (hereinafter also simply referred to as “information processing apparatus 100”) will be described with reference to FIGS. 9 and 10. The information processing apparatus 100 is capable of generating model data for a database (hereinafter referred to as “model data”). This makes it possible to avoid a situation in which a field name is wrongly set by making a mistake in typing or for other reasons, and in which a text object corresponding to a field name is not present in edition data (for example, template data).

The configuration of the information processing apparatus 100 will be described with reference to FIG. 9. FIG. 9 is a block diagram illustrating an example of functional constituents of the information processing apparatus 100 according to Embodiment 3. The information processing apparatus 100 includes a database obtaining unit 101, a template obtaining unit 102, an identification unit 103, a generation unit 104, an output control unit 105, and a model generation unit 901. Note that in the following description, processes the same as or similar to those of the information processing apparatus 100 according to Embodiment 1 are denoted by the same symbols as in FIG. 1, and description thereof is omitted. Note that processes of the units included as functional constituents in the information processing apparatus 100 are implemented by hardware such as an ASIC or an FPGA included in the information processing apparatus 100 in a way the same as or similar to that in the information processing apparatus 100 according to Embodiment 1. These processes may be implemented by software with memory such as RAM and a processor such as a CPU.

The model generation unit 901 extracts the character string of each text object included in edition data such as template data obtained by the template obtaining unit 102 and generates model data of a database having field names of the extracted character strings. For example, when the user presses the model creation button 307 illustrated in FIG. 3, the model generation unit 901 generates model data. The identification unit 103 uses the database created based on the model data to identify the text object including the character string that completely matches each field name. The generation unit 104 generates layout data by using the database created based on the model data and replacing the character strings of text objects included in edition data.

The operation of the information processing apparatus 100 will be described with reference to FIG. 10. FIG. 10 is a flowchart illustrating an example of the process flow of the information processing apparatus 100 according to Embodiment 3. Specifically, the flowchart of illustrated in FIG. 10 is for the information processing apparatus 100 to generate model data of a database. Note that in the description of FIG. 10, the symbol “S” denotes “step”. Here, it is assumed that while the flowchart illustrated in FIG. 10 is being executed, the output control unit 105 generates appropriate GUIs as necessary and displays the generated GUIs on the display unit 205. In addition, the following description is based on the assumption that when the flowchart illustrated in FIG. 10 starts, the process at S601 in FIG. 6 has been completed.

The flowchart illustrated in FIG. 10 starts when the model creation button 307 illustrated in FIG. 3 is pressed. When the model creation button 307 is pressed, first, the model generation unit 901, at S1001, generates an empty database in which field names and record data have not been set. The generated empty database is stored, for example, in the RAM 203. Next, at S1002, the model generation unit 901 searches the template data obtained at S601 for a first text object. Next, at S1003, the model generation unit 901 determines whether a text object was detected.

If it is determined at S1003 that a text object was not detected, the model generation unit 901, at S1008, generates a file of the empty database stored in the RAM 203, as model data, and outputs the file to the auxiliary storage apparatus 204 or the like. In this case, the model data stored in the auxiliary storage apparatus 204 or the like as a file is an empty database in which field names have not been set. Hence, in this case, the model generation unit 901 does not have to output model data. In this case, the output control unit 105 may generate a GUI showing an error indicating that appropriate model data could not be outputted and display the generated GUI on the display unit 205.

If it is determined at S1003 that a text object is detected, the model generation unit 901, at S1004, extracts the character string of the detected text object and sets the character string as a first field name of the database stored in the RAM 203. After S1004, the model generation unit 901, at S1005, searches the template data obtained at S601 for another text object. Specifically, the model generation unit 901 searches the template data for a text object other than the text object already detected. After S1005, the model generation unit 901, at S1006, determines whether another text object was detected.

If it is determined at S1006 that a text object was detected, the model generation unit 901, at S1007, extracts the character string of the detected text object and sets the character string as the next field name of the database stored in the RAM 203. After S1007, the information processing apparatus 100 returns to the process at S1005 and executes the processes from S1005 to S1007 repeatedly until it is determined at S1006 that a text object was not detected. If it is determined at S1006 that a text object was not detected, the model generation unit 901, at S1008, generates a file of the database stored in the RAM 203, as model data, and outputs the file to the auxiliary storage apparatus 204 or the like. After S1008, the information processing apparatus 100 ends the processes in the flowchart illustrated in FIG. 10. The user adds record data to the generated model data as appropriate and creates a database. The information processing apparatus 100, at S602 in FIG. 6, obtains the database created from the model data and performs the processes at S603 and below in FIG. 6 to generate layout data.

The field names of the database generated by the information processing apparatus 100 configured as described above will not have a wrong setting due to a mistake in typing or the like. Hence, since the information processing apparatus 100 uses a database generated based on created model data, it is possible to prevent a wrong field name from being set due to a mistake in the user's typing or the like. Thus, the information processing apparatus 100 can prevent a failure in replacing the character string of a desired text object.

Note that in the foregoing model data, the character strings of all of the text objects included in edition data are set as field names. Hence, for example, the user may delete the field names for which the user does not want to replace the character string of the text object and may generate a database from the model data after deletion. In addition, for example, for the field names for which the user does not want to replace the character string of the text object, the user may make the record data in the columns corresponding to the field names blank data or the like. In this case, the information processing apparatus 100 is configured not to replace the character strings of the text objects corresponding to the field names the record data of which is blank data or the like.

Although in the present embodiment, all of the text objects included in edition data are sequentially searched for, the method of searching for text objects is not limited to this one. For example, the user selects in advance, in the preview image 306, only the text objects that the user desires to set as field names and presses the model creation button 307 in the selected state. In this way, only the character strings of the selected text objects may be set as field names.

### Embodiment 4

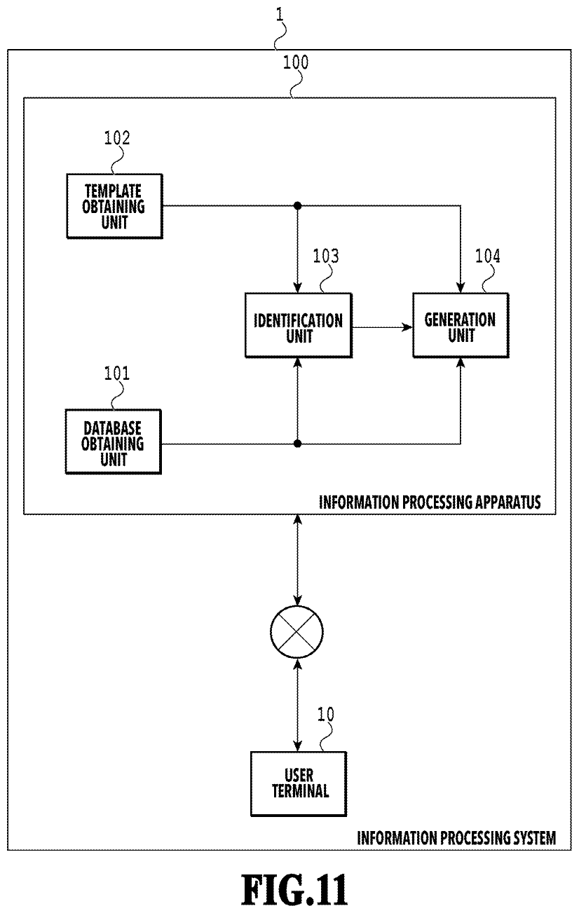

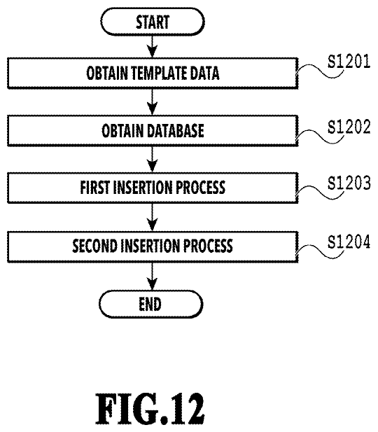

An information processing apparatus 100 according to Embodiment 4 (hereinafter also simply referred to as “information processing apparatus 100”) will be described with reference to FIGS. 11 and 12. The present embodiment describes a configuration in which layout data for variable data printing is generated by using a Web application. The configuration of the information processing apparatus 100 will be described with reference to FIG. 11. FIG. 11 is a block diagram illustrating an example of functional constituents of the information processing apparatus 100 according to Embodiment 4. The information processing apparatus 100 includes, as functional constituents, a database obtaining unit 101, a template obtaining unit 102, an identification unit 103, a generation unit 104, and an output control unit 105. The information processing apparatus 100 may include, in addition to these functional constituents, at least one of a similarity retrieving unit 701 and a model generation unit 901 not illustrated in FIG. 11 as a functional constituent. The information processing apparatus 100 is a server configured to operate as a back-end of a Web application, and the server has the hardware configuration illustrated in FIG. 2 as an example. The processes of the units included as functional constituents in the information processing apparatus 100 are implemented, for example, by software with memory such as the RAM 203 and a processor such as the CPU 201. In the following, the processes of the units included as functional constituents in the information processing apparatus 100 are approximately the same as or similar to the processes of the units included as functional constituents in the information processing apparatus 100 according to Embodiments 1 to 3; hence only the differences will be described.

The information processing apparatus 100 is applied to an information processing system 1, which includes the information processing apparatus 100 that operates as a back-end of a Web application and a user terminal 10 that operates as a front-end of the Web application. The information processing apparatus 100 and the user terminal 10 are communicably connected to each other via a communication line 11 such as Internet. The user terminal 10 is composed of a PC, a mobile terminal, a laptop PC, a tablet terminal, a PDA, or the like capable of operating a Web browser.

The information processing apparatus 100 generates information to generate a GUI such as the editing screen 300 illustrated in FIG. 3 as an example and transmits the information to the user terminal 10 via the communication line 11. The information is rendered by the Web browser operating in the user terminal 10, and the user terminal 10 displays the GUI corresponding to the information on the display apparatus not illustrated in FIG. 11, included in or connected to the user terminal 10.

The operation of the information processing apparatus 100 will be described with reference to FIG. 12. FIG. 12 is a flowchart illustrating an example of the process flow of the information processing apparatus 100 according to Embodiment 4. Note that in the description of FIG. 12, the symbol “S” denotes “step”. Here, it is assumed that while the flowchart illustrated in FIG. 12 is being executed, the output control unit 105 generates information to generate appropriate GUIs as necessary and transmits the information to the user terminal 10. It is also assumed that the user terminal 10 generates GUIs corresponding to the received information and displays the GUIs on the display apparatus as necessary.

First, at S1201, the template obtaining unit 102 obtains template data. Specifically, for example, the user selects a thumbnail image 303 corresponding to the template data, included in an editing screen 300 displayed on the Web browser. The user terminal 10 transmits information indicating the selected thumbnail image 303 to the information processing apparatus 100 via the communication line 11. The template obtaining unit 102 obtains template data by loading the template data corresponding to the thumbnail image 303 indicated by the information from the auxiliary storage apparatus 204 or the like.

The method of obtaining template data is not limited to the above one. For example, the user may operate the editing screen 300 to create new template data. In this case, the template obtaining unit 102 obtains the newly created template data. Alternatively, for example, the user may operate the editing screen 300 to select template data prestored in a storage apparatus not illustrated in FIG. 11, included in or connected to the user terminal 10. In this case, the user terminal 10 reads the selected template data from the storage apparatus and transmits the template data to the information processing apparatus 100 via the communication line 11. The template obtaining unit 102 obtains the template data received from the user terminal 10.

Next, at S1202, the database obtaining unit 101 obtains a database 400. Specifically, for example, the user operates the editing screen 300 to select a database 400 prestored in a storage apparatus not illustrated in FIG. 11, included in or connected to the user terminal 10. The user terminal 10 reads the selected database 400 from the storage apparatus and transmits the read database 400 to the information processing apparatus 100 via the communication line 11. The database obtaining unit 101 obtains the database 400 received from the user terminal 10. Note that since some databases include personal information such as individuals' names and addresses, the user terminal 10 may perform processing such as encryption or obfuscation on the read database and transmit the processed database to the information processing apparatus 100.

Next, at S1203, the identification unit 103 performs a first insertion process. The first insertion process corresponds to the processes from S603 to S608 illustrated in FIG. 6. In this process, the identification unit 103 identifies, for each field name included in the database 400, a text object including the character string corresponding to the field name out of the text objects included in the template data obtained at S1201.

Next, at S1204, the generation unit 104 performs a second insertion process. The second insertion process corresponds to the processes from S611 to S615 illustrated in FIG. 6. With this process, the generation unit 104 generates layout data corresponding to each record of the database 400. Note that the information processing apparatus 100 transmits each piece of the layout data generated at S1204 to the user terminal 10 via the communication line 11. The user terminal 10 outputs the layout data received from the information processing apparatus 100, for example, to a storage apparatus not illustrated in FIG. 11, included in or connected to the user terminal 10 and stores the layout data in the storage apparatus. Note that output destination of the received layout data is not limited to the storage apparatus above. For example, the user terminal 10 may output the received layout data to an image forming apparatus such as a printer, not illustrated in FIG. 11, connected to the user terminal 10 and may print (record) it onto printing media. Note that to print the received layout data on printing media with an image forming apparatus, the user terminal 10 may output the received layout data to a printer driver or the like and cause the printer driver to execute printing of the layout data. After S1204, the information processing apparatus 100 ends the processes in the flowchart illustrated in FIG. 12.

Note that although the present embodiment described a configuration in which the information processing apparatus 100 transmits each pieces of the layout data generated at S1204 to the user terminal 10, the output destination of each pieces of the layout data generated at S1204 is not limited to the user terminal 10. For example, the information processing apparatus 100 may output each pieces of the layout data generated at S1204 to an apparatus connected to the information processing apparatus 100 such as a file server or an image forming apparatus not illustrated in FIG. 11, designated in advance by the user or the like.

Although the present embodiment has been described on the assumption that all of the processes of the database obtaining unit 101, the template obtaining unit 102, the identification unit 103, and the generation unit 104 included in the information processing apparatus 100 are executed in the information processing apparatus 100, the present disclosure is not limited to this configuration. For example, one or all of the processes performed by at least one of the database obtaining unit 101, the template obtaining unit 102, the identification unit 103, and the generation unit 104 may be executed in the user terminal 10 that operates as the front-end of the Web application.

With the information processing apparatus 100 configured as described above, it is possible to generate layout data for variable data printing on a Web application by using a database in which field names associated with text objects can be recognized on the database.

### OTHER EMBODIMENTS

Embodiment(s) of the present disclosure can also be realized by a computer of a system or apparatus that reads and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory apparatus, a memory card, and the like.

With the present disclosure, it is possible to generate print data for variable data printing by using a database in which field names associated with text objects can be recognized on the database.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-84980, filed May 25, 2022 which is hereby incorporated by reference wherein in its entirety.

What is claimed is:

1. An information processing method comprising:
obtaining a database;
identifying, out of one or more text objects included in edition data indicating a layout, a text object of the text objects including a character-string data piece corresponding to an attribute character-string data piece indicating each of one or more attributes included in the database; and
generating layout data by replacing the character-string data piece included in the text object identified in the identifying with a data piece in a record included in the database, the data piece in the record corresponding to the attribute associated with the text object.

2. The information processing method according to claim 1, wherein
in the generating, the layout data corresponding to each of one or more of the records included in the database is generated.

3. The information processing method according to claim 1, further comprising:
comparing the length of a character string to be replaced in the generating, included in the text object with the length of the character string of the data piece in the record; and
output controlling of, in a case where a situation in which the length of the character string of the data piece in the record is longer than the length of the character string included in the text object occurs, controlling output so as to enable a user to realize information indicating the situation.

4. The information processing method according to claim 1, further comprising:
comparing the length of a character string to be replaced in the generating, included in the text object with the length of the character string of the data piece in the record; and
reducing, in a case where the length of the character string of the data piece in the record is longer than the length of the character string included in the text object, the font size of the character string of the data piece in the record, wherein
in the generating, in a case where the length of the character string of the data piece in the record is longer than the length of the character string included in the text object, the character-string data piece included in the text object is replaced with data of the record in which the font size is reduced in the reducing.

5. The information processing method according to claim 3, wherein
in the comparing, the length of the character string included in the text object is compared with the length of the character string of the data piece in the record by comparing the number of characters in the two corresponding character strings.

6. The information processing method according to claim 3, wherein
in the comparing, the length of the character string included in the text object is compared with the length of the character string of the data piece in the record by comparing the widths of the two corresponding character strings displayed in two images obtained by rendering the edition data and the layout data.

7. The information processing method according to claim 1, wherein
in the identifying, the text object including a character string of the character-string data piece identical with a character string of the attribute character-string data piece is identified to be the text object corresponding to the attribute indicated by the attribute character-string data piece.

8. The information processing method according to claim 1, further comprising
similarity-retrieving of searching search targets of one or more character-string data pieces for a character-string data piece similar to a specified character-string data piece, and detecting a character-string data piece corresponding to the specified character-string data piece out of the search targets, wherein
in a case where the text object corresponding to the attribute is unable to be identified in the identifying,
in the similarity-retrieving, out of the search targets which are a character-string data piece included in each of the one or more text objects included in the edition data, a character-string data piece similar to the attribute character-string data piece indicating the attribute to which the text object corresponds was unable to be identified in the identifying is retrieved, and
in the generating, the character-string data piece of the text object detected in the similarity-retrieving is replaced with the data piece in the record corresponding to the attribute indicated by the attribute character-string data piece used in retrieving in the similarity-retrieving.

9. The information processing method according to claim 8, further comprising:
output-controlling of controlling output so as to enable a user to recognize each of the one or more character-string data pieces detected in the similarity-retrieving; and
selection-obtaining of obtaining information indicating the character-string data piece selected by the user out of the one or more character-string data pieces the output of which is controlled in the output-controlling, wherein
in a case where the text object corresponding to the attribute is unable to be identified in the identifying,
in the similarity-retrieving, out of the search targets which are a character-string data piece included in each of the one or more text objects included in the edition data, a character-string data piece similar to the attribute character-string data piece indicating the attribute to which the text object corresponds was unable to be identified in the identifying is retrieved,
in the output-controlling, output of one or more character-string data pieces of the text objects detected in the similarity-retrieving is controlled,
in the selection-obtaining, information indicating the character-string data piece of the text object selected by the user is obtained, and
in the generating, according to the information obtained in the selection-obtaining, the character-string data piece of the text object selected by the user is replaced with a data piece in the record corresponding to the attribute indicated by the attribute character-string data piece used in retrieving in the similarity-retrieving.

10. The information processing method according to claim 8, wherein
in the similarity-retrieving, a character-string data piece similar to the specified character-string data piece is detected out of the search targets by searching the search targets for a character-string data piece including a character string corresponding to part of the character string indicated by the specified character-string data piece.

11. The information processing method according to claim 1, wherein
in the identifying, in a case where a plurality of the text objects including a character-string data piece corresponding to the attribute character-string data piece are present, the text object corresponding to the attribute is uniquely identified out of the plurality of text objects including the character-string data piece corresponding to the attribute character-string data piece.

12. The information processing method according to claim 1, further comprising
model-generating of extracting, out of the one or more text objects included in the edition data, at least one character-string data piece included in the text objects, and generating model data for the database in which the extracted character-string data piece is set as the attribute character-string data piece, wherein
in the identifying, the text object corresponding to the attribute is identified by using the database created based on the model data, and
in the generating, the layout data is generated by using the database created based on the model data.

13. The information processing method according to claim 1, wherein
the edition data is template data including the text objects arranged in advance.

14. The information processing method according to claim 1, wherein
the edition data is data including the text objects arranged by a user.

15. An information processing apparatus comprising:
one or more hardware processors; and
one or more memories storing one or more programs configured to be executed by the one or more hardware processors, the one or more programs including instructions for:
obtaining a database;
identifying, out of one or more text objects included in edition data indicating a layout, a text object of the text objects including a character-string data piece corresponding to an attribute character-string data piece indicating each of one or more attributes included in the database; and
generating layout data by replacing the character-string data piece included in the identified text object with a data piece in a record included in the database, the data piece in the record corresponding to the attribute associated with the text object.

16. A non-transitory storage medium storing a program causing a computer to execute:
obtaining a database;
identifying, out of one or more text objects included in edition data indicating a layout, a text object of the text objects including a character-string data piece corresponding to an attribute character-string data piece indicating each of one or more attributes included in the database; and
generating layout data by replacing the character-string data piece included in the text object identified in the identifying with a data piece in a record included in the database, the data piece in the record corresponding to the attribute associated with the text object.
